(19) United States
(12) Patent Application Publication
(10) Pub. No.: US 2023/0097448 A1
(43) Pub. Date: Mar. 30, 2023

(54) Tilted Fiber Optic Splice Storage Drawer and Storage System

(71) Applicant: All Systems Broadband, Inc., Livermore, CA (US)

(72) Inventors: Craig Dwayne Ray, Raleigh, NC (US); Steven Witkoe, Liberty Lake, WA (US)

(21) Appl. No.: 17/947,742

(22) Filed: Sep. 19, 2022

Related U.S. Application Data
(60) Provisional application No. 63/248,701, filed on Sep. 27, 2021.

(51) Int. Cl. G02B 6/44

(52) U.S. Cl. CPC G02B 6/4455; G02B 6/4452

(57) ABSTRACT

A fiber optic splice storage drawer includes a lower panel, a splice tray receptacle, bend controls, and first and second mounting brackets that each comprise an attachment plate and an inner wall oriented transversely to the attachment plate, wherein the lower panel is disposed between the first and second mounting brackets with opposite facing outer edge sides of the lower panel facing the inner walls of the first and second mounting brackets, respectively, wherein the lower panel is movably secured to the inner walls of the first and second mounting brackets, wherein the lower panel is oriented on a first plane that is tilted relative a mounting surface of the attachment plate, and wherein the fiber optic splice storage drawer is movable between an open position and a closed position with the lower panel of remaining on the first plane.

### TECHNICAL FIELD

The present invention generally relates to telecommunication hardware, and particularly relates to devices for mounting and storing splices of fiber optic cable.

### BACKGROUND

Today's communication networks provide transport of voice, video and data to both residential and commercial customers, with more and more of those customers being connected by fiber optic cables. In these communication networks, information is transmitted from one location to another by sending pulses of light through the fiber optic cables. Fiber optic transmission provides several advantages, such as increased bandwidth over distance with lower losses and maintenance, in comparison to traditional electrical transmission techniques.

Fiber optic networks include fiber optic connection boxes to store and secure splices of optical fiber and associated lengths of fiber optic cable feeding into the splices. These fiber optic connection boxes are often provided at network termination points. For example, a fiber optic connection box may be provided at a network termination point between service-provider network cabling and customer-side fiber optic cabling.

Modern network bandwidth and connectivity demands for fiber optic networks result in increasing number of fiber optic cables and/or increasing number of optical fibers per cable at a given termination point. For example, a termination point may be required to accommodate splices between fiber optic cables having optical fiber counts of 864, 1152, 1728, 3456, 6912, etc. Solutions are needed to store high density fiber optic splices in an organized and space-efficient manner, while simultaneously providing access to the stored fiber optic splices in an ergonomic and user-friendly manner.

### SUMMARY

A fiber optic splice storage drawer is disclosed. According to an embodiment, the fiber optic splice storage drawer comprises a lower panel, a splice tray receptacle disposed on or within a planar surface of the lower panel, bend controls disposed on the lower panel, and first and second mounting brackets that each comprise an attachment plate and an inner wall oriented transversely to the attachment plate, wherein the lower panel is disposed between the first and second mounting brackets with opposite facing outer edge sides of the lower panel facing the inner walls of the first and second mounting brackets, respectively, wherein the lower panel is movably secured to the inner walls of the first and second mounting brackets, wherein the lower panel is oriented on a first plane that is tilted relative a mounting surface of the attachment plate, and wherein the fiber optic splice storage drawer is movable between an open position and a closed position with the lower panel of remaining on the first plane.

Separately or in combination, the fiber optic splice storage drawer further comprises first and second outer sidewalls that are disposed on either side of the lower panel and extend transversely to the lower panel, first and second drawer slides that are respectively attached to the inner walls of the first and second mounting brackets and to the first and second outer sidewalls, wherein the first and second drawer slides are arranged to slide along the first plane.

Separately or in combination, the splice tray receptacle is disposed between the bend controls and a front edge of the lower panel, wherein the front edge of the lower panel moves away from the first and second mounting brackets as the lower panel is moved from the closed position to the open position.

Separately or in combination, the splice tray receptacle and the bend controls are each disposed behind the attachment plates of the first and second mounting brackets in the closed position and in front of the attachment plates in the open position.

Separately or in combination, the fiber optic splice storage drawer further comprises outer coil guide walls disposed on the lower panel, wherein the outer coil guide walls are disposed on an opposite side of the bend controls as the splice tray receptacle, and wherein the outer coil guide walls are disposed in front of the attachment plates in the open position.

Separately or in combination, the fiber optic splice storage drawer further comprises unobstructed spans of the front edge that extend at least substantially close to the outer edge sides of the lower panel.

Separately or in combination, the first plane is oriented at an angle of between 75 degrees and 15 degrees relative to the mounting surface of the attachment plate, the angle of orientation being measured between a lower surface of the lower panel that is opposite from the bend controls and the mounting surface of the attachment plate.

Separately or in combination, the fiber optic splice storage drawer further comprises first and second fastening mechanisms disposed on the first and second outer sidewalls, respectively, wherein the first and second fastening mechanisms engage with the inner walls of the first and second mounting brackets, respectively, in the closed position, and wherein the first and second fastening mechanisms are releasable from the inner walls of the first and second mounting brackets so as to permit unrestricted movement of the first and second drawer slides in the open position.

Separately or in combination, the first and second fastening mechanisms comprise latches disposed on the first and second outer sidewalls, respectively, wherein the inner walls of the first and second mounting brackets each comprise perforations, and wherein the latches of the first and second fastening mechanisms are insertably retained within the perforations of the inner walls, respectively.

A fiber optic splice storage assembly is disclosed. According to an embodiment, the fiber optic splice storage assembly comprises a rack comprising first and second rails that are spaced apart from one another and each comprise a planar mounting surface, a plurality of fiber optic splice storage drawers, each of the fiber optic splice storage drawers comprising a lower panel, a splice tray receptacle disposed on or within a planar surface of the lower panel, bend controls disposed on the lower panel; and first and second mounting brackets, wherein each of the fiber optic splice storage drawers in the plurality are movably secured to the first and second rails by the first and second mounting brackets of the respective fiber optic splice storage drawers, wherein the lower panels of each of the fiber optic splice storage drawers are parallel to a first plane that is tilted relative to the planar mounting surface, and wherein each of the plurality of fiber optic splice storage drawers are movable between an open position and a closed position with the lower panels of each of the fiber optic splice storage drawers remaining parallel to the first plane.

Separately or in combination, the first and second mounting brackets of each of the fiber optic splice storage drawers comprise an inner wall and an attachment plate oriented transversely to the attachment plate, wherein the lower panel of each of the fiber optic splice storage drawers is movably secured to the inner walls of the respective first and second mounting brackets, and wherein the attachment plates of the first and second mounting brackets from each of the fiber optic splice storage drawers are flush against and secured to the first and second rails, respectively.

Separately or in combination, the rack further comprises a wall mount frame that is behind the first and second rails, wherein the first and second rails and the wall mount frame define an interior volume of the rack, wherein the fiber optic splice storage drawers are disposed substantially within the interior volume in the closed position and are disposed substantially outside of the interior volume in the open position.

Separately or in combination, all contents of the fiber optic splice storage drawers are disposed in front of the first and second rails in the open position.

Separately or in combination, the first plane is oriented at an angle of between 60 degrees and 30 degrees relative to the planar mounting surface.

Separately or in combination, an interior volume from the each of the of fiber optic splice storage drawers is accessible by side entrances that extend over outer edge sides of the lower panels that face the inner walls of the first and second mounting brackets, respectively.

Separately or in combination, at least one of the fiber optic splice storage drawers comprises a fiber optic splice holder that is securely retained by the splice tray receptacle and comprises a plurality of optical splice retainers, and a fiber optic splice between a pair of fiber optic cables that is securely retained by one of the optical splice retainers.

Separately or in combination, the at least one of the fiber optic splice storage drawers further comprises slack lengths from the pair of fiber optic cables that are organized in a coil that wraps around the bend controls, wherein the fiber optic splice holder is disposed within a center of the coil.

Separately or in combination, each of the cables from the pair comprises rollable ribbon fiber optic cable with at least 288 optical fibers.

Separately or in combination, the at least one of the fiber optic splice storage drawers further comprises outer sidewalls that are disposed at outer edge sides of the lower panel and upper panels that extend from the sidewalls over the lower panel, wherein the coil is contained within an interior volume defined by the lower panel, the outer sidewalls, and the upper panels.

Separately or in combination, the interior volume is accessible by unobstructed spans of the outer edge sides of the lower panel that are adjacent the outer sidewalls.

### BRIEF DESCRIPTION OF THE DRAWINGS

FIG. 1 illustrates a fiber optic splice storage drawer with splices between fiber optic cables and slack lengths of fiber optic cables stored therein, according to an embodiment.

FIG. 2 schematically illustrates the orientation of the attachment plates from the fiber optic splice storage drawer relative to the lower panel of the fiber optic splice storage drawer, according to an embodiment.

FIG. 3 illustrates a fiber optic splice storage assembly comprising a rack and a plurality of fiber optic splice storage drawers mounted on the rack, according to an embodiment.

FIG. 4, which includes FIGS. 4A and 4B, schematically illustrates one installer in the case of FIG. 4A or two installers in the case of FIG. 4B performing a splice installation with one of the fiber optic splice storage drawers from a fiber optic splice storage assembly in an open position, according to an embodiment.

FIG. 5 illustrates a side view of a fiber optic splice storage assembly with fiber optic cables being routed into side entrances of the fiber optic splice storage drawers, according to an embodiment.

FIG. 6 illustrates a fiber optic splice storage assembly with a fiber optic splice storage drawer in an open position, according to an embodiment.

### DETAILED DESCRIPTION

Embodiments of a fiber optic splice storage drawer and a storage rack for mounting and securing a plurality of the fiber optic splice storage drawers together are described herein. The rack can comprise a pair of spaced apart rails, and each of the fiber optic splice storage drawers can be secured to the pair of spaced apart rails by mounting brackets disposed on outer sides of the fiber optic splice storage drawers. An installer that faces the front of the rack can access the contents within the fiber optic splice storage drawers by pulling the fiber optic splice storage drawers away from a front side of the rack. Advantageously, the fiber optic splice storage drawers are mounted on a plane that is tilted relative to the front attachment surface of the rack. More particularly, the fiber optic splice storage drawers may tilt downward such that a front edge of the fiber optic splice storage drawers is closer to the floor than a rear edge of the drawer. Moreover, the fiber optic splice storage drawers are movable between an open position and a closed position while remaining on this tilted plane. As a result, the contents stored in the drawer and the features of the drawer itself are presented ergonomically to an installer standing or sitting in front of the rack. The tilted plane makes splicing of the optical fibers easy to effectuate by an installer from a level that is at or below the drawer and eliminates the need to for the installer to elevate to a level that is above the drawer to effectuate splices. Instead, an installer may be situated as much as 5 feet below the front edge of the drawer during installation.

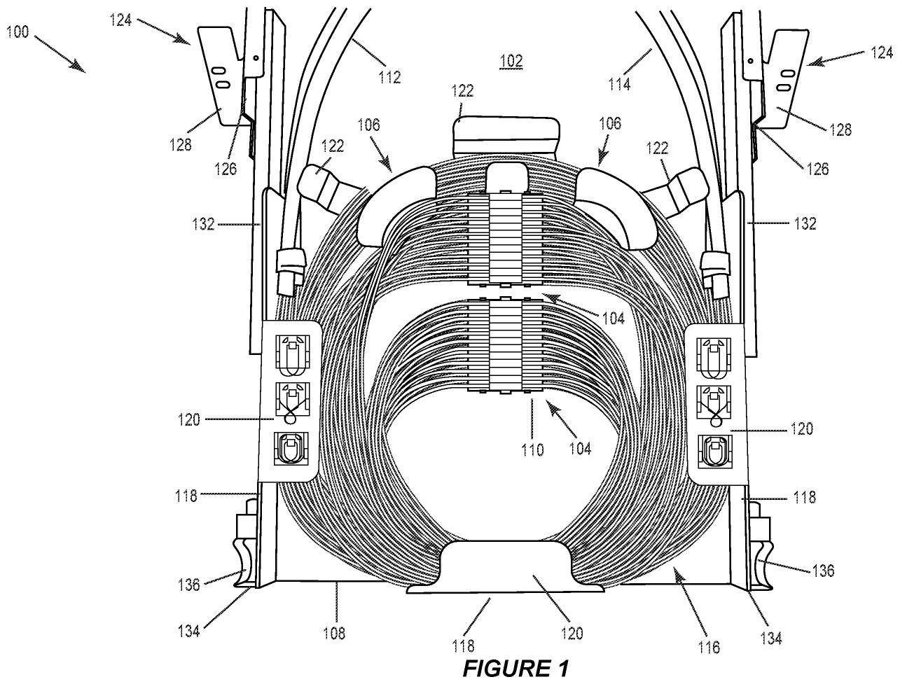

Referring to FIG. 1, a fiber optic splice storage drawer 100 comprises a lower panel 102, a splice tray receptacle 104 disposed on or within a planar surface of the lower panel 102, and curve shaped bend controls 106 disposed on the lower panel 102. The splice tray receptacle 104 is disposed between the bend controls 106 and a front edge 108 of the lower panel 102. The splice tray receptacle 104 is dimensioned to receive and securely retain a fiber optic splice holder 110. The fiber optic splice holder 110 can be a modular tray with optical splice retainers that are designed to securely retain splices of optical fiber. Moreover, the fiber optic splice holder 110 comprises stacking features that allow for multiple identical ones of the fiber optic splice holders 110 to be stacked on top of one another. The components of the fiber optic splice storage drawer 100 and the elements stored therein including the splice tray receptacle 104, the bend controls 106, and the fiber optic splice holders 110 can be substantially similar or identical to the correspondingly named features described in International PCT Application PCT/US2021/033683 filed on May 21, 2021, the content of which is incorporated by reference herein in its entirety.

A first fiber optic cable 112 is routed into an interior volume of the fiber optic splice storage drawer 100 and a second fiber optic cable 114 is routed into an interior volume of the fiber optic splice storage drawer 100. The first and second fiber optic cables 112, 114 may comprise so-called rollable ribbon fiber optic cable. Rollable ribbon fiber optic cable is a particular kind of high-density cable that includes a high number optical fibers. A single rollable ribbon fiber optic cable can have optical fiber counts of at least 288 optical fibers, e.g., 864 optical fibers, 1152 optical fibers, 1728 optical fibers, 3456 optical fibers, 6912 optical fibers, etc. In rollable ribbon fiber optic cable, the optical fibers rest in a tightly wrapped spiral arrangement. By applying compressive force to the cable, these fibers project out from the spiral, allowing for easy access to each fiber. More generally, fiber optic cables routed into and stored by the fiber optic splice storage drawer 100 may include any of a variety of different cable types. Exemplary cable types include single mode cable, multi-mode cable, indoor-outdoor cable, loose buffer tube cable, and conventional or flat ribbon fiber cable.

The fiber optic splice storage drawer 100 comprises a plurality of fiber optic splice holders 110 secured within the interior volume of the fiber optic splice storage drawer 100. These fiber optic splice holders 110 securely retain fiber optic splices between optical fibers from the first and second fiber optic cables 112, 114. Each of the fiber optic splice holders 110 comprises a plurality of optical splice retainers. The fiber optic splices can be covered and protected by a splice protection sleeve, which in turn is retained by one of the optical splice retainers. The fiber optic splice holders 110 are arranged in multi-tiered stacks, with lowermost ones of the fiber optic splice holders 110 from each stack being inserted in and securely retained by the splice tray receptacles 104.

Excess slack lengths of optical fibers that are exposed from the jacketed portions of the first and second fiber optic cables 112, 114 and feed into the splices are organized in a coil 116 that is stored within the fiber optic splice storage drawer 100. Each of the fiber optic splice holders 110 are disposed within a center of the coil 116. The curve shaped bend controls 106 are arranged to define the inner radius of the coil 116 and to create the shape of the coil 116 when an installer wraps the slack lengths of optical fibers around the bend controls 106.

The fiber optic splice storage drawer 100 comprises outer sidewalls 118 that are disposed at outer edge sides of the lower panel 102 and upper panels 120 that extend from the outer sidewalls 118 over the lower panel 102. According to an embodiment, the outer sidewalls 118 are substantially perpendicular to the lower panel 102 and form an angled intersection with the lower panel 102. Likewise, the upper panels 120 may be substantially perpendicular to the lower panel 102 and form an angled intersection with the lower panel 102. Alternatively, the outer sidewalls 118 and upper panels 120 may form any type of conduit shape with the lower panel 102, e.g., C-shape, U-shape, etc. The outer sidewalls 118 and the upper panels 120 define an interior volume of the fiber optic splice storage drawer 100, i.e., a three dimensional space which accommodates the contents stored within the storage drawer 100, and constrain the coil 116 within the interior volume of the fiber optic splice storage drawer 100. Stated another way, the outer sidewalls 118 define outer lateral boundaries of the fiber optic splice storage drawer 100 that prevent the fiber optic cable from laterally expanding outside of the fiber optic splice storage drawer 100, and the upper panels 120 define vertical boundaries that prevent the fiber optic cable from vertically expanding outside of the fiber optic splice storage drawer 100. As shown, the fiber optic splice storage drawer 100 may additionally comprise outer coil guide walls 122 that are disposed on the lower panel 102 on an opposite side of the bend controls 106 as the splice tray receptacle 104. The outer coil guide walls 122 define an opposing boundary for the coil 116 opposite from the bend controls 106 and guide the first fiber optic cable 112 and the second first fiber optic cable 112 into the interior volume away from the coil 116.

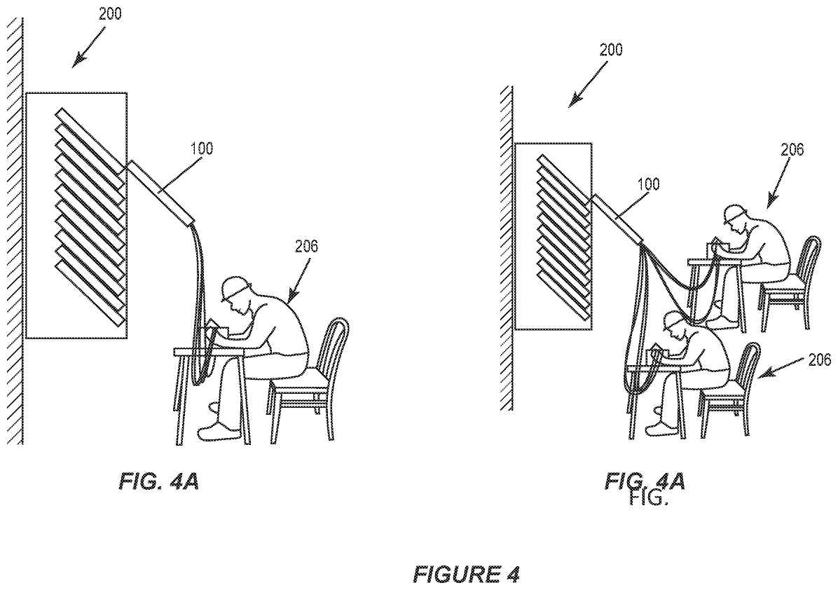

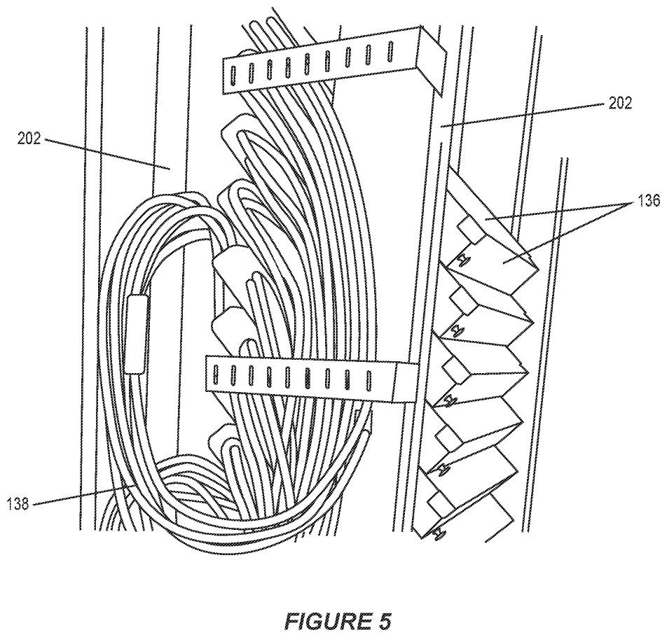

According to an embodiment, the interior volume of the fiber optic splice storage drawer 100 is accessible by unobstructed spans of the outer edge sides of the lower panel 102 that are adjacent the outer sidewalls 118. That is, interruptions are provided in the outer sidewalls 118 so that fiber optic cable may pass directly into the interior volume without passing over one of the outer sidewalls 118 or through a port provided in one of the outer sidewalls 118. As shown, the unobstructed spans comprise spans of the front edge 108 extending towards opposite facing outer edge sides of the lower panel 102. These unobstructed spans at the front edge 108 allow for excess slack lengths of optical fiber to be easily routed out from the interior volume while splices are being effectuated, e.g., in the manner depicted in FIG. 4. The depicted arrangement illustrates just one possible configuration. More generally, unobstructed spans of the front edge 108 can be provided at any one or two locations, and may not necessarily extend completely to the outer edge sides of the lower panel 102. The unobstructed spans may comprise spans of the outer edge sides of the lower panel 102 that are behind the outer sidewalls 118. These outer edge side unobstructed spans provide side entrances for the first and second fiber optic cables 112 to be routed into the interior volume of the of the fiber optic splice storage drawer 100, e.g., in the manner depicted in FIG. 5.

The fiber optic splice storage drawer 100 further comprises first and second mounting brackets 124 disposed on either side of the lower panel 102. The first and second mounting brackets 124 are configured to securely mount the fiber optic splice storage drawer 100 to a receptacle structure, such as an equipment rack. The first and second mounting brackets 124 each comprise an inner wall 126 and an attachment plate 128. The inner wall 126 and the attachment plate 128 may each be planar sheets of a material, such as metal or plastic, that are oriented on different planes, but are permanently connected together to form a stable mechanical connection.

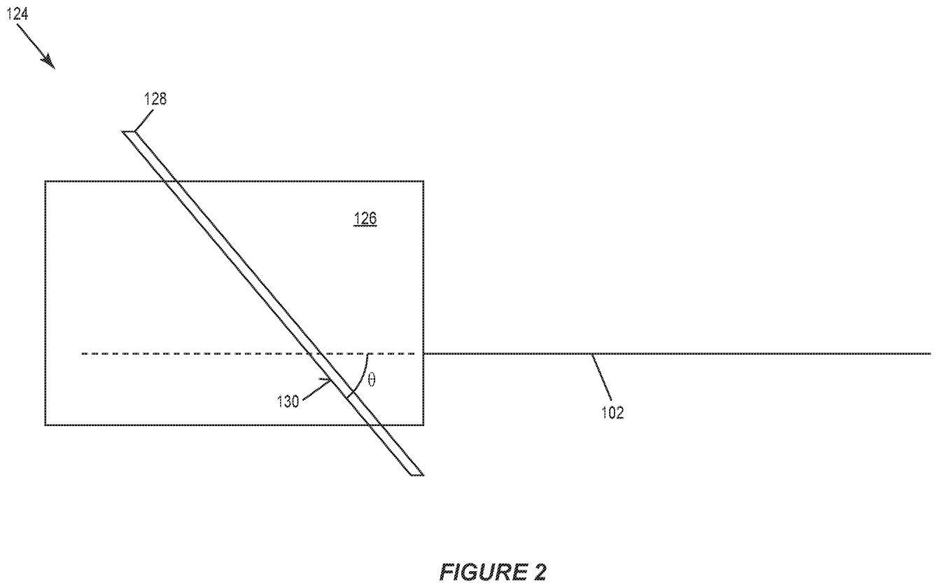

Referring to FIG. 2, the relative orientations of the surfaces from the first and second mounting brackets 124 and the lower panel 102 are shown. The inner wall 126 of the mounting brackets 124 is oriented transversely attachment plate 128, meaning that the outer surfaces of these structures extend along different planes. Moreover, a mounting surface 130 of the attachment plate 128 extends along a plane that is tilted relative to the plane of the lower panel 102. In this context, a plane that is tilted relative another plane means that the two planes form an oblique angle with one another. For example, the mounting surface 130 of the attachment plate 128 may extend along a plane which forms an angle θ of between 75 degrees and 15 degrees relative to the plane of the lower panel 102. In one particular embodiment, this angle θ is roughly 45 degrees., e.g., anywhere between 48 degrees and 42 degrees.

The angled orientation of the mounting surface 130 relative to the lower panel 102 results in the lower panel 102 extending along a plane that is tilted relative to the surface to which the mounting bracket 124 is affixed to. Thus, if the mounting bracket 124 is affixed to a surface that extends in a vertical direction perpendicular to a floor, the lower panel 102 will tilt downward towards the floor.

Referring again to FIG. 1, the lower panel 102 is disposed between the first and second mounting brackets 124 with opposite facing outer edge sides of the lower panel 102 facing the inner walls 126 of the first and second mounting brackets 124, respectively. The lower panel 102 is movably secured to the inner walls 126 of the first and second mounting brackets 124. That is, the lower panel 102 and the inner walls 126 of the first and second mounting brackets 124 are mechanically coupled to one another, but the lower panel 102 is permitted to move along a defined range of motion relative to the first and second mounting brackets 124. For example, as shown, the fiber optic splice storage drawer 100 may comprise first and second drawer slides 132 that are respectively attached to the inner walls 126 of the first and second mounting brackets 124. The attachment between these structures may be provided by fasteners such as screws. The first and second drawer slides 132 are also attached to first and second ones of the outer sidewalls 118 that are disposed on either side of the lower panel 102, and in turn are permanently affixed to the lower panel 102. In a commonly known manner, the first and second drawer slides 132 are configured to slidably protract and retract along a movement plane. Generally speaking, the first and second drawer slides 132 can be any type of drawer slide, e.g., ball bearing drawer slide, roller slide, etc. The first and second drawer slides 132 can have different mounting configurations from what is shown, e.g., under mount, center mount, etc., in which case the mounting brackets 124 can adapted accordingly. More generally, the fiber optic splice storage drawer 100 may incorporate any type of sliding mechanism that permits the lower panel 102 to move along a fixed plane relative to the first and second mounting brackets 124.

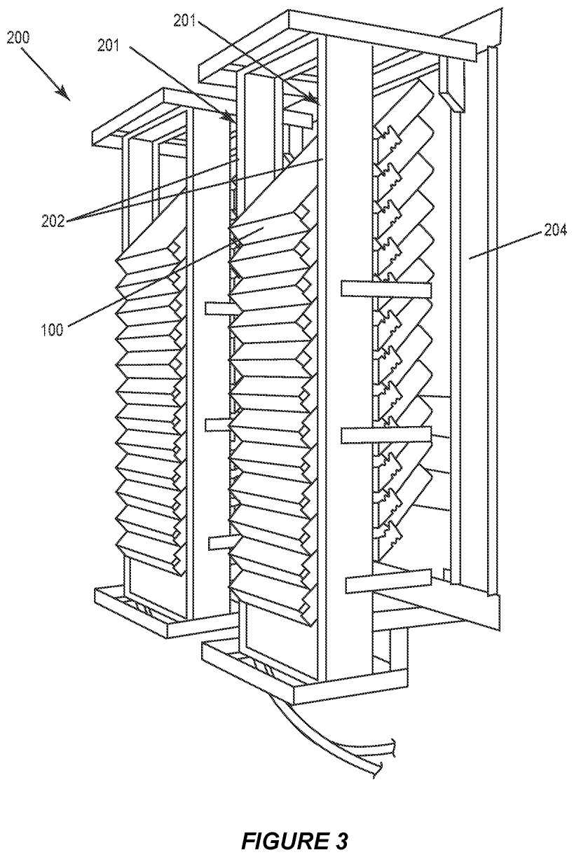

The fiber optic splice storage drawer 100 is movable between an open position and a closed position. In the closed position (shown in FIGS. 3 and 5), the front edge 108 of the lower panel 102 is substantially close to the inner walls 126 of the first and second mounting brackets 124. In this position, the inner walls 126 of the first and second mounting brackets 124 may be in contact with or close to outer tabs 134 that are provided above the front edge 108 of the lower panel 102. The fiber optic splice storage drawer 100 may comprise first and second fastening mechanisms 136. In the closed position, the first and second fastening mechanisms 136 engage with the inner walls 126 of the first and second mounting brackets 124, respectively. The first and second fastening mechanisms 136 are releasable from the inner walls 126 of the first and second mounting brackets 124 so as to permit unrestricted movement of the first and second drawer slides 132 in the open position. As shown, the first and second fastening mechanisms 136 comprise latches disposed on the first and second outer sidewalls 118 sidewalls, respectively, and the inner walls 126 of the first and second mounting brackets 124 each comprise perforations. In the closed position, the latches of the first and second fastening mechanisms 136 are insertably retained within the perforations of the inner walls 126, respectively. An installer can release the latches through moderate tactile manipulation, thereby allowing the lower panel 102 to move away from the first and second mounting brackets 124 via the drawer slides 132. More generally, the lower panel 102 of the fiber optic splice storage drawer 100 can be secured to the first and second mounting brackets 124 by any type of fastening mechanism or mechanisms, e.g., brackets, push pins, screws, etc.

FIG. 1 illustrates the fiber optic splice storage drawer 100 in the open position. As the fiber optic splice storage drawer 100 is moved from the from the closed position to the open position, the front edge 108 of the lower panel 102 moves away from the first and second mounting brackets 124. The open position refers to a position wherein the front edge 108 of the lower panel 102 is the furthest away from the first and second mounting brackets 124 to the extent permitted by the sliding mechanism or mechanisms. As shown, in the open position, all of the interior features of the fiber optic splice storage drawer 100 that are disposed on the lower panel 102, e.g., the splice tray receptacle 104, the bend controls 106, and the outer coil guide walls 122 are disposed in front of the attachment plates 128. In this way, these features and components, e.g., the fiber optic splice holders 110 and the coil 116, are easily accessible to an installer. Conversely, in the closed position, all of these features and components stored in the fiber optic splice storage drawer 100 can be protected from the exterior environment, e.g., when a front cover 136 is provided as shown in FIG. 4.

According to an embodiment, fiber optic splice storage drawer 100 is movable between the open position and the closed position with the lower panel 102 remaining on a first plane that is tilted relative to the mounting surface 130 of the attachment plate 132. That is, the angle θ between the mounting surface 130 of the attachment plate 128 and the lower panel 102 as shown in FIG. 2 remains constant across the full range of motion between the open position and the closed position. This is due to the configuration of the first and second mounting brackets 124 and the connection mechanism between the first and second mounting brackets 124 and the lower panel 102. For example, the first and second drawer slides 132 can be arranged along the first plane that is tilted relative to the relative to the mounting surface 130 of the attachment plate 132 and parallel to the plane of the lower panel 102. In this way, the lower panel 102 moves along this first plane between the open position and the closed position.

According to another embodiment, the fiber optic splice storage drawer 100 moves along a plane that is substantially perpendicular to the mounting surface 130 as it is moved from the closed position to the open position. In this embodiment, the fiber optic splice storage drawer 100 can comprise a sliding mechanism that is arranged to slide the fiber optic splice storage drawer 100 along the plane that is substantially perpendicular to the mounting surface 130 and the mounting brackets 124 may be suitably adapted for this orientation. Moreover, the fiber optic splice storage drawer 100 may further comprise a pivot mechanism, such as a hinge, that is disposed at the rear side of the fiber optic splice storage drawer 100, and permits the fiber optic splice storage drawer 100 to be tilted from the plane that is substantially perpendicular to the mounting surface 130 to a plane that is tilted relative to the mounting surface 130, which may be the same as the first plane as described above, once the sliding mechanism is protracted. Stated another way, the tilting of the fiber optic splice storage drawer 100 can be achieved by compound movements instead of along a fixed plane.

Referring to FIG. 3, a fiber optic splice storage assembly comprises a rack 200 with a plurality of the fiber optic splice storage drawers 100 secured to the rack 200. The rack 200 comprises first and second rails 202 that are laterally spaced apart from one another. The rack 200 is configured so that the first and second rails 202 are securely affixed to a wall or other vertical support structure, e.g., post, board, etc. extending up from a floor. To this end, the rack 200 further comprises a wall mount frame 204 that is behind the first and second rails 202. As shown, the wall mount frame 204 comprises a pair of spaced apart rails, which in turn comprise perforations that allow the wall mount frame 204 to be secured to a wall or other vertical support structure by fasteners such as screws, bolts, etc. More generally, the wall mount frame 204 can comprise any structure that is adapted to securely affix the rack 200 to a wall or other vertical support structure, and may include continuous planar structure.

The first and second rails 202 comprise planar mounting surfaces 201 that are adapted to receive the planar mounting surfaces 130 from fiber optic splice storage drawer 100. The planar mounting surfaces 201 of the first and second rails 202 may be parallel to the wall or other vertical support structure to which the rack 200 is secured to and/or to perpendicular the floor beneath the rack 200. The first and second rails 202 together with the wall mount frame 204 define an interior volume of the rack 200. In the closed position, the lower panels 102 of the fiber optic splice storage drawers 100 are disposed substantially within the interior volume of the rack 200 in the closed position. That is, with the exception of a small part of the lower panel 102 that extends to the front edge 108 side of the lower panel 102, which may be no greater than 5 to 15% of an overall area of the lower panel 102, the remaining area of the lower panel 102 is within the interior volume of the rack 200 in the closed position.

The planar mounting surfaces 201 of the first and second rails 202 mate with the attachment plates 128 from the mounting brackets 124 of the fiber optic splice storage drawers 100 to secure the fiber optic splice storage drawers. In particular, the mounting surfaces 130 from the attachment plates 128 are flush against the planar mounting surfaces 201 of the first and second rails 202, and a fastener such as a screw, pin or bolt is inserted through aligned perforations in each structure.

In the assembly, the lower panel 102 of each of the fiber optic splice storage drawers 100 is parallel to a first plane that is tilted relative to the planar mounting surfaces 201 of the first and second rails 202. This is due to the configuration of the attachment plates 128 as described above, and the fact that the planar mounting surfaces 201 of the first and second rails 202 are flush against and parallel to the mounting surfaces 130 from the attachment plates 128 of each of the fiber optic splice storage drawers 100.

Referring to FIG. 4, an example of an installer 206 (in the case of FIG. 4A) or installers 206 (in the case of FIG. 4B) effectuating fiber optic splices that are to be stored in the fiber optic splice storage assembly is shown. In the depicted assembly, an uppermost one of the fiber optic splice storage drawers 100 is in the open position, with each of the subjacent fiber optic splice storage drawers 100 being in the closed position. Due to the mounting position of the fiber optic splice storage drawers 100 being tilted downward towards the floor, and the movement of the fiber optic splice storage drawers 100 along the plane that is tilted downward towards the floor, the assembly advantageously allows the installer 206 to access the interior volume of each of the fiber optic splice storage drawers 100 without requiring a latter or stool. Moreover, the tilting of the fiber optic splice storage drawers 100 reduces the transition angle of the fiber optic cable as it extends over the front edge 108 of lower panel 102 (as shown in FIG. 1) and downward towards the installer 206. This minimizes bending and pinching of the fiber optic cable, and allows the installer to work at a position that is substantially below the fiber optic splice storage drawers 100 without fear of damaging the cable. In the example of FIG. 4B, two installers 206 are effectuating splices simultaneously, thereby decreasing the amount of time needed to effectuate each required splice. This setup may be aided by a drawer having unobstructed spans in two outer regions of the front edge 108 of lower panel 102, e.g., as shown in FIG. 1, with a central one of the outer sidewalls 118 in the middle. This arrangement naturally channels the cable towards the two installers 106 that are sitting apart from one another.

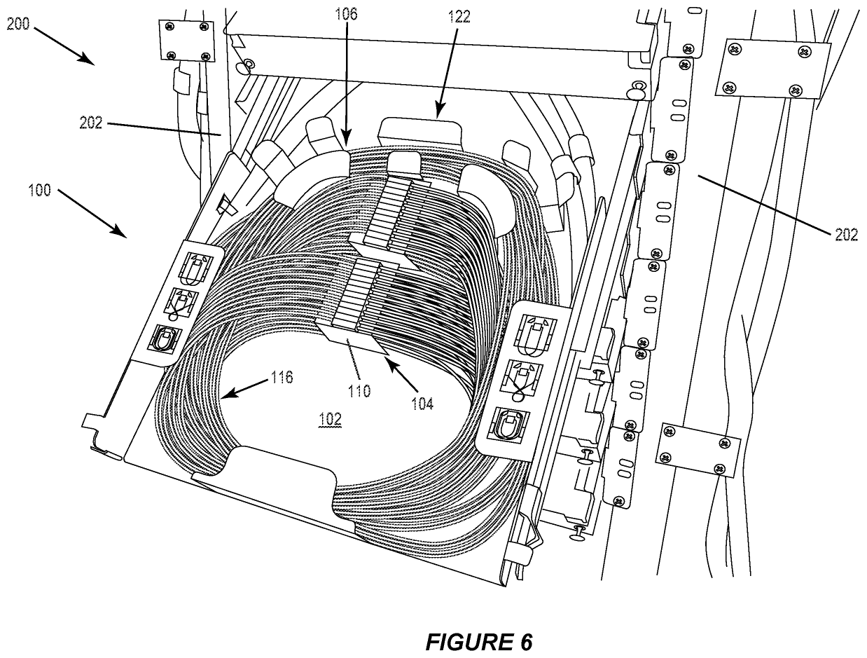

Referring to FIG. 5, a side view of the fiber optic splice storage assembly with each of the fiber optic splice storage drawers 100 being in the closed position is shown. Each of the fiber optic splice storage drawers 100 may further comprise a cover 136 that extends over the interior volume of the respective fiber optic splice storage drawers 100, thereby confining and protecting the components stored therein. The cover 136 may extend to the front edges 108 of lower panel 102 and attach to the tabs 134 that extend from the first and second outer sidewalls 118. The cover 136 may be completely removable from the fiber optic splice storage drawer 100, e.g., as shown in FIG. 6. More generally, a variety of different cover structures may be provided which form a complete or partial roof over the fiber optic splice storage drawers 100.

As also illustrated shown in FIG. 5, large fiber optic cables 138 are fed into the interior volume of the fiber optic splice storage drawers 100 through side entrances. These fiber optic cables 138 may correspond to the first fiber optic cable 112 as described with reference to FIG. 1, with the second fiber optic cable 114 being fed into a side entrance at an opposite side of the fiber optic splice storage drawers 100. As can be seen, there is adequate clearance for the large fiber optic cables 138 to bend and tilt downward towards the front side of the fiber optic splice storage drawers 100. In this way, the fiber optic splice storage drawers 100 can be moved between the open and closed position without damaging or substantially bending or pulling on the large fiber optic cables 138.

Referring to FIG. 6, a frontal view of the fiber optic splice storage assembly with one of the fiber optic splice storage drawers 100 being in the open position is shown. As can be seen, the lower panel 102 of the opened fiber optic splice storage drawer 100 is disposed substantially outside of the interior volume of the rack 200 in the open position. That is, with the exception of a part of the lower panel 102 that extends to a rear edge side of the lower panel 102, which may be no greater than 5 to 30% of an overall area of the lower panel 102, the remaining area of the lower panel 102 is outside the interior volume of the rack 200. In this way, all contents that are stored within the fiber optic splice storage drawers 100, e.g., the fiber optic splice holders 110 and the coil 116 of fiber optic cable, along with the features used to secure these contents, e.g., the splice tray receptacle 104, the bend controls 106, and the outer coil guide walls 122, are disposed in front of the first and second rails 202 in the open position and are thus easily accessed by an installer 206.

Spatially relative terms such as “under,” “below,” “lower,” “over,” “upper,” “top,” bottom” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having,” “containing,” “including,” “comprising” and the like are open-ended terms that indicate the presence of stated elements or features, but do not preclude additional elements or features. The articles “a,” “an” and “the” are intended to include the plural as well as the singular, unless the context clearly indicates otherwise.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A fiber optic splice storage drawer, comprising:
a lower panel;
a splice tray receptacle disposed on or within a planar surface of the lower panel;
bend controls disposed on the lower panel; and
first and second mounting brackets that each comprise an attachment plate and an inner wall oriented transversely to the attachment plate,
wherein the lower panel is disposed between the first and second mounting brackets with opposite facing outer edge sides of the lower panel facing the inner walls of the first and second mounting brackets, respectively,
wherein the lower panel is movably secured to the inner walls of the first and second mounting brackets,
wherein the lower panel is oriented on a first plane that is tilted relative a mounting surface of the attachment plate, and
wherein the fiber optic splice storage drawer is movable between an open position and a closed position with the lower panel of remaining on the first plane.

2. The fiber optic splice storage drawer of claim 1, further comprising:
first and second outer sidewalls that are disposed on either side of the lower panel and extend transversely to the lower panel;
first and second drawer slides that are respectively attached to the inner walls of the first and second mounting brackets and to the first and second outer sidewalls,
wherein the first and second drawer slides are arranged to slide along the first plane.

3. The fiber optic splice storage drawer of claim 2, wherein the splice tray receptacle is disposed between the bend controls and a front edge of the lower panel, wherein the front edge of the lower panel moves away from the first and second mounting brackets as the lower panel is moved from the closed position to the open position.

4. The fiber optic splice storage drawer of claim 3, wherein the splice tray receptacle and the bend controls are each disposed behind the attachment plates of the first and second mounting brackets in the closed position and in front of the attachment plates in the open position.

5. The fiber optic splice storage drawer of claim 4, further comprising outer coil guide walls disposed on the lower panel, wherein the outer coil guide walls are disposed on an opposite side of the bend controls as the splice tray receptacle, and wherein the outer coil guide walls are disposed in front of the attachment plates in the open position.

6. The fiber optic splice storage drawer of claim 3, wherein the fiber optic splice storage drawer comprises unobstructed at spans of the front edge that extend at least substantially close to the outer edge sides of the lower panel.

7. The fiber optic splice storage drawer of claim 2, wherein the first plane is oriented at an angle of between 75 degrees and 15 degrees relative to the mounting surface of the attachment plate, the angle of orientation being measured between a lower surface of the lower panel that is opposite from the bend controls and the mounting surface of the attachment plate.

8. The fiber optic splice storage drawer of claim 2, further comprising first and second fastening mechanisms disposed on the first and second outer sidewalls, respectively, wherein the first and second fastening mechanisms engage with the inner walls of the first and second mounting brackets, respectively, in the closed position, and wherein the first and second fastening mechanisms are releasable from the inner walls of the first and second mounting brackets so as to permit unrestricted movement of the first and second drawer slides in the open position.

9. The fiber optic splice storage drawer of claim 8, wherein the first and second fastening mechanisms comprise latches disposed on the first and second outer sidewalls, respectively, wherein the inner walls of the first and second mounting brackets each comprise perforations, and wherein the latches of the first and second fastening mechanisms are insertably retained within the perforations of the inner walls, respectively.

10. A fiber optic splice storage assembly, comprising:
a rack comprising first and second rails that are spaced apart from one another and each comprise a planar mounting surface;
a plurality of fiber optic splice storage drawers, each of the fiber optic splice storage drawers comprising a lower panel, a splice tray receptacle disposed on or within a planar surface of the lower panel, bend controls disposed on the lower panel; and first and second mounting brackets,
wherein each of the fiber optic splice storage drawers in the plurality are movably secured to the first and second rails by the first and second mounting brackets of the respective fiber optic splice storage drawers,
wherein the lower panels of each of the fiber optic splice storage drawers are parallel to a first plane that is tilted relative to the planar mounting surface, and
wherein each of the plurality of fiber optic splice storage drawers are movable between an open position and a closed position with the lower panels of each of the fiber optic splice storage drawers remaining parallel to the first plane.

11. The fiber optic splice storage assembly of claim 10, wherein the first and second mounting brackets of each of the fiber optic splice storage drawers comprise an inner wall and an attachment plate oriented transversely to the attachment plate, wherein the lower panel of each of the fiber optic splice storage drawers is movably secured to the inner walls of the respective first and second mounting brackets, and wherein the attachment plates of the first and second mounting brackets from each of the fiber optic splice storage drawers are flush against and secured to the first and second rails, respectively.

12. The fiber optic splice storage assembly of claim 10, wherein the rack further comprises a vertical support mounting structure that is behind the first and second rails, wherein the first and second rails and the vertical support mounting structure define an interior volume of the rack, wherein the fiber optic splice storage drawers are disposed substantially within the interior volume in the closed position and are disposed substantially outside of the interior volume in the open position.

13. The fiber optic splice storage assembly of claim 12, wherein all contents of the fiber optic splice storage drawers are disposed in front of the first and second rails in the open position.

14. The fiber optic splice storage assembly of claim 12, wherein the first plane is oriented at an angle of between 15 degrees and 75 degrees relative to the planar mounting surface.

15. The fiber optic splice storage assembly of claim 12, wherein an interior volume from the each of the of fiber optic splice storage drawers is accessible by side entrances that extend over outer edge sides of the lower panels that face the inner walls of the first and second mounting brackets, respectively.

16. The fiber optic splice storage assembly of claim 12, wherein at least one of the fiber optic splice storage drawers comprises:
a fiber optic splice holder that is securely retained by the splice tray receptacle and comprises a plurality of optical splice retainers; and
a fiber optic splice between a pair of fiber optic cables that is securely retained by one of the optical splice retainers.

17. The fiber optic splice storage assembly of claim 16, wherein the at least one of the fiber optic splice storage drawers further comprises slack lengths from the pair of fiber optic cables that are organized in a coil that wraps around the bend controls, wherein the fiber optic splice holder is disposed within a center of the coil.

18. The fiber optic splice storage assembly of claim 16, wherein each of the cables from the pair comprises rollable ribbon fiber optic cable with at least 288 optical fibers.

19. The fiber optic splice storage assembly of claim 16, wherein the at least one of the fiber optic splice storage drawers further comprises outer sidewalls that are disposed at outer edge sides of the lower panel and upper panels that extend from the sidewalls over the lower panel, wherein the coil is contained within an interior volume defined by the lower panel, the outer sidewalls, and the upper panels.

20. The fiber optic splice storage assembly of claim 16, wherein the interior volume is accessible by unobstructed spans of the outer edge sides of the lower panel that are adjacent the outer sidewalls.
